(19) United States
(12) Patent Application Publication
(10) Pub. No.: US 2020/0377286 A1
(43) Pub. Date: Dec. 3, 2020

(54) MEDICINE BOTTLE INSERT

(71) Applicant: Dose Defense, LLC, Versailles, KY (US)

(72) Inventors: Adelinn Jane Preston, Versailles, KY (US); Abigail Maureen Cheek, Versailles, KY (US); Anthony Micah Brock, Versailles, KY (US); Allison Layne Birch, Versailles, KY (US)

(21) Appl. No.: 16/884,610

(22) Filed: May 27, 2020

Related U.S. Application Data
(60) Provisional application No. 62/853,330, filed on May 28, 2019.

(51) Int. Cl. B65D 83/04; A61J 1/03

(52) U.S. Cl. CPC B65D 83/0409; B65D 2583/0472; A61J 1/03

(57) ABSTRACT

A pill bottle insert that may be coupled with a pill bottle to increase the time and effort required to dispense each pill. The insert includes a cap portion, from which a cone extends downwards into the bottle. A hole passes through the cap portion, proximately to the narrowest diameter of the cone, while the widest diameter of the cone is substantially similar to the interior diameter of the bottle, such that pills moving towards the mouth of the bottle will be received by the cone, and directed towards the hole. The hole may be sized and shaped to provide a desired level of effort to dispense each pill, depending upon the size and shape of the pills. The cone may also include diverters projecting from the interior wall, that may be sized and shaped to further restrict dispensing.

### PRIORITY

This application claims priority to U.S. Provisional Application Ser. No. 62/853,330, filed May 28, 2019, and titled “Medicine Bottle Insert,” the disclosure of which is hereby incorporated by reference in its entirety.

### FIELD

The disclosed technology pertains to an insert for medicine bottles.

### BACKGROUND

Accidental overdose is a common and sometimes dangerous occurrence, whether for prescription medicines, over the counter medicines, or even vitamin supplements. Some of the most common accidental overdoses involve children, who may mistakenly believe that a medication or vitamin is candy. Conventional safety mechanisms, such as threaded child safety caps, are child resistant, but not child proof, and in some cases may be overcome in just a few minutes of effort by a child. Once removed, the child can immediately empty the entire contents of the bottle, which sometimes may include 500 or more tablets, and consume many of them before determining they are not candy. Even the most common pain killers, vitamins, and cold remedies can be dangerous, or even deadly, when taken in unconstrained amounts, especially for children.

While the example above refers to children, this may also occur with adults with impaired cognitive abilities or other handicaps, and who may require an assistant to help them safely access and take their medicines without accidentally overdosing.

What is needed, therefore, is an improved safety mechanism for medicine bottles.

### BRIEF DESCRIPTION OF THE DRAWINGS

The drawings and detailed description that follow are intended to be merely illustrative and are not intended to limit the scope of the invention as contemplated by the inventors.

FIG. 1 is a perspective view of an exemplary bottle insert;

FIG. 2 is a perspective view of an alternative exemplary bottle insert;

FIG. 3 is a side elevation view of the bottle insert of FIG. 2;

FIG. 4 is a cross-sectional side elevation view of the bottle insert of FIG. 2;

FIG. 5 is a bottom view of the bottle insert of FIG. 2;

FIG. 6 is a top down view of the bottle insert of FIG. 2;

FIG. 7A shows an exemplary pill bottle;

FIG. 7B shows the pill bottle of FIG. 7A with the bottle insert of FIG. 1 or 2 inserted;

FIG. 7C shows the pill bottle of FIG. 7A with the bottle insert of FIG. 1 or 2 inserted, and a cap removed, from above;

FIG. 7D shows the pill bottle of FIG. 7A with the bottle insert of FIG. 1 or 2 inserted, and a cap removed, from below;

FIG. 8A shows a side elevation view of an exemplary threaded bottle insert;

FIG. 8B shows a cross sectional side elevation view of the threaded bottle insert of FIG. 8A;

FIG. 9A is a perspective view of another exemplary bottle insert;

FIG. 9B is a side elevation view of the bottle insert of FIG. 9A;

FIG. 9C is a top down view of the bottle insert of FIG. 9A;

FIG. 9D is a bottom view of the bottle insert of FIG. 9A; and

FIG. 10 shows a schematic diagram of a bottle insert positioned within a bottle.

### DETAILED DESCRIPTION

The inventors have conceived of novel technology that, for the purpose of illustration, is disclosed herein as applied in the context of medicine bottle safety mechanisms. While the disclosed applications of the inventors' technology satisfy a long-felt but unmet need in the art of medicine bottle safety mechanisms, it should be understood that the inventors' technology is not limited to being implemented in the precise manners set forth herein, but could be implemented in other manners without undue experimentation by those of ordinary skill in the art in light of this disclosure. Accordingly, the examples set forth herein should be understood as being illustrative only, and should not be treated as limiting.

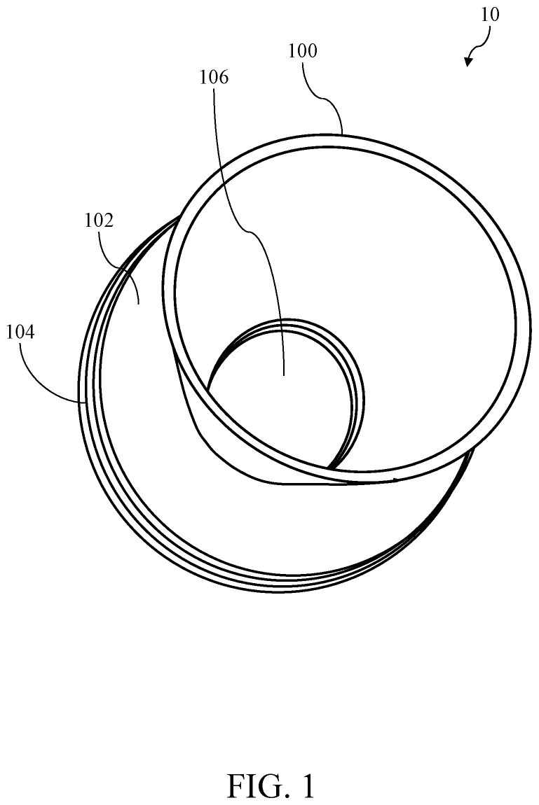

FIG. 1 is a perspective view of an exemplary bottle insert (10). The bottle insert (10) may be placed in a pill bottle, in order to reduce the size of an opening, and slow the rate at which pills may be dispensed from the pill bottle. The bottle insert (10) includes a cap portion (102), from which extends a flow control portion, referred to herein after as a cone (100). A hole (106) for dispensing passes through the cap portion (102), and is positioned substantially centrally on the cap portion (102), though it should be understood that the hole (106) may be positioned elsewhere on the cap portion (102) in varying implementations. A bottle catch (104) along the circumference of the cap portion (102) is adapted to couple the bottle insert (10) with a pill bottle when inserted therein. The bottle catch (104) may be, for example, a deformable material such as a rubber or plastic seal or ring, a wedge shaped edge, or another feature adapted to friction fit the bottle insert (10) within a bottle and prevent it from falling out during normal use. The bottle catch (104) may also be a catch that matches a ridge or other corresponding feature within the interior of the bottle, and which snaps, clicks, or otherwise engages with the corresponding feature when inserted to prevent dislodging. When inserted, the cap portion (102) of the bottle insert (10) may be flush with the edge of the bottle, such that it cannot be easily pried out with a fingernail or tool.

The bottle insert (10) may be inserted, with the cone (100) leading, into a pill bottle during installation. The widest portion of the cone (100) is directed downwards, into the bottle, and the circumference of that portion will substantially match the circumference of the interior of the bottle, such that when the pill bottle is tipped to dispense a pill the pills are received by the cone (100) and directed towards the hole (106). The hole (106) will have a circumference smaller than that of the interior of the bottle, and will in some implementations be sized depending upon the type of pill contained in the bottle. As an example, for an oblong pill that is about 2 cm long, having a diameter of about 1 cm, the hole (106) may have a diameter of between 1 cm and 2 cm, such that the oblong pill can only dispense one at a time, and may also require some manipulation of the bottle to rearrange pills within so that the oblong pill can enter the hole (106) longitudinally.

While such features of the bottle insert (10) may not completely mitigate the risk of a person defeating other safety features of a medicine bottle and gaining access to the medication therein, it will substantially increase the amount of effort required to dispense each individual pill, and so will serve as a friction deterrent that may prevent, or greatly reduce the number of pills dispensed by a child or other individual before they lose interest. As an example, rather than being able to immediately dump 500 ibuprofen tablets from an opened bottle, a bottle with the pill insert (10) may increase the time and effort required to dispense each individual pill such that only a few may be easily dispensed each minute, and thus may both increase the amount of time and noise created during dispensing, allowing an adult or other guardian to detect what is occurring, and may reduce the number of pills dispensed in the first few minutes after the bottle is accessed from 500 to less than 10.

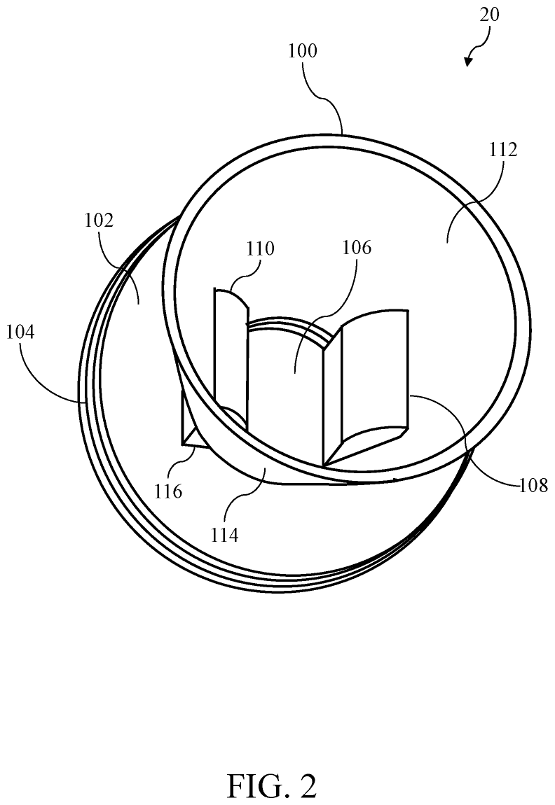

FIG. 2 is a perspective view of an exemplary bottle insert (20), sharing some features with the bottle insert (10). The bottle insert (20) includes the cone (100), the cap portion (102), the bottle catch (104), and the hole (106), having substantially similar features and functions as described in the context of the bottle insert (10) of FIG. 1. The bottle insert (20) also includes, projecting from an interior wall (112) of the cone (100), a first diverter (108) and a second diverter (110). The diverters (108, 110) are positioned within the cone (100) and proximate to the hole (106), such that they change the shape and dimensions of the hole (106), as well as the portion of the cone (100) leading to the hole (106). The diverters (108, 110) may be positioned and shaped to further restrict dispensing of pills through the hole (106), by limiting the portion of the cone (100) that leads to the hole (106) (e.g., the number of pills that may gather immediately proximate to the hole (106) may be reduced from 10 or more, to only 1 or 2), and by further specifying the dimensions of pills that may exit the hole (106) (e.g., the dimensions shown in FIG. 2 may substantially match the diameter or length of a single longitudinal pill, and may require that the pill singularly pass between the diverters (108, 110) during its approach to the hole (106).

The structure of the diverters (108, 110) may entirely project from the interior wall (112) of the cone (100), or may pass through an exterior wall (114) and join with the cap portion (102) to form several supports (116), in some implementations. Versions of the bottle insert (20) that include one or more supports (116), which couple the cone (100) to the cap portion (102), and provide additional stability beyond the connection between the circumference of the cone's narrowest point, may be more robust and re-usable than those where the cone (100) is only supported at its narrowest circumference.

It should also be understood that, while FIG. 2 shows two diverters (108, 110) having a gradual curve outwards from the interior wall (112), terminating at the hole (106), other configurations exist and will be apparent to those of ordinary skill in the art in light of this disclosure. As an example, some implementations may only have a single diverter extending from the interior wall (112), or may have three or more diverters projecting from the interior wall (112), both proximate to the hole (106) and elsewhere, to further impede the free flow of pills through the cone (100). Further, such diverters may be straight, rounded, curved, or may include concave cups, ledges, or other elements that may catch and obstruct the free flow of pills through the cone (100). These variations and others may be implemented as structures within the cone (100) to achieve a desired level of difficulty or effort for dispensing, by requiring additional manipulation, shaking, rotating, and general adjusting of the coupled bottle to receive each pill.

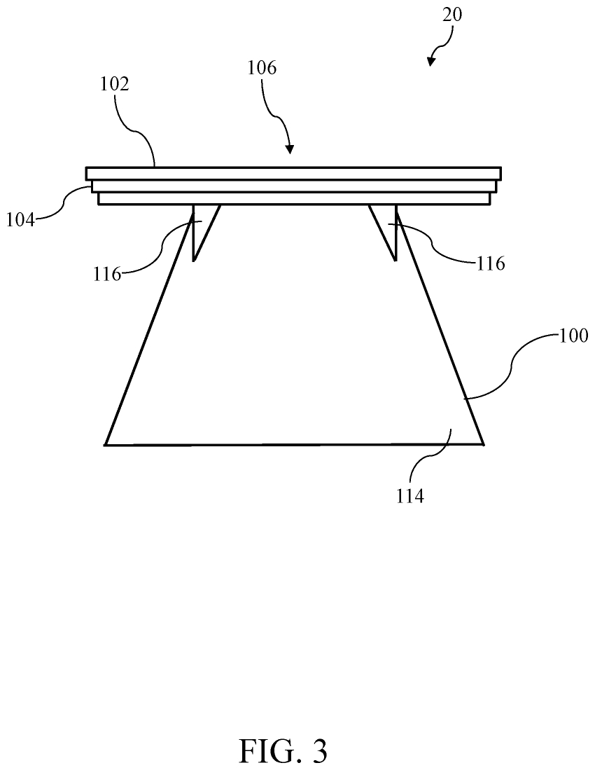

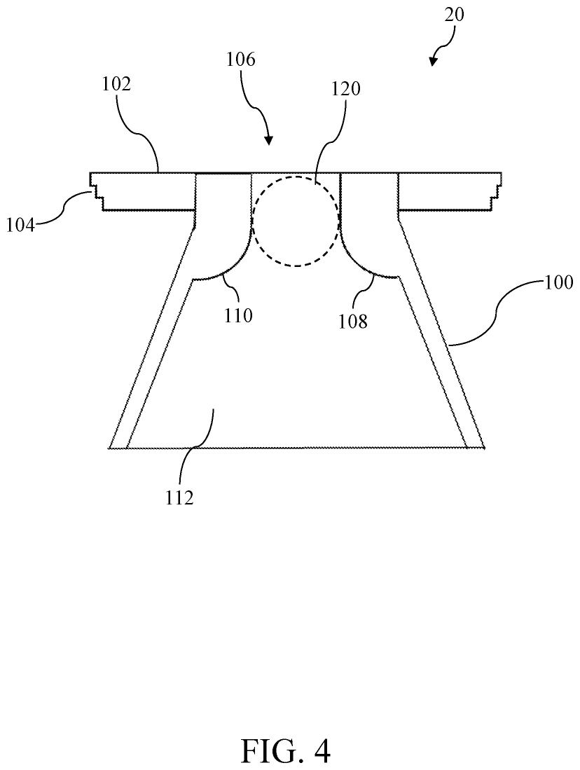

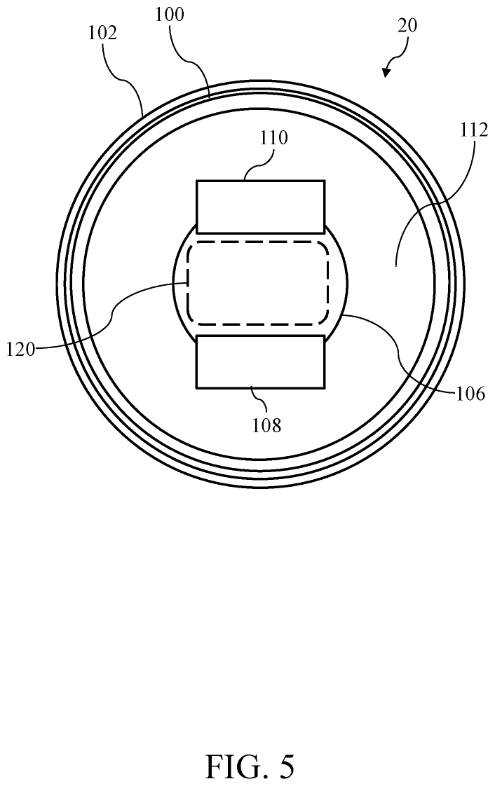

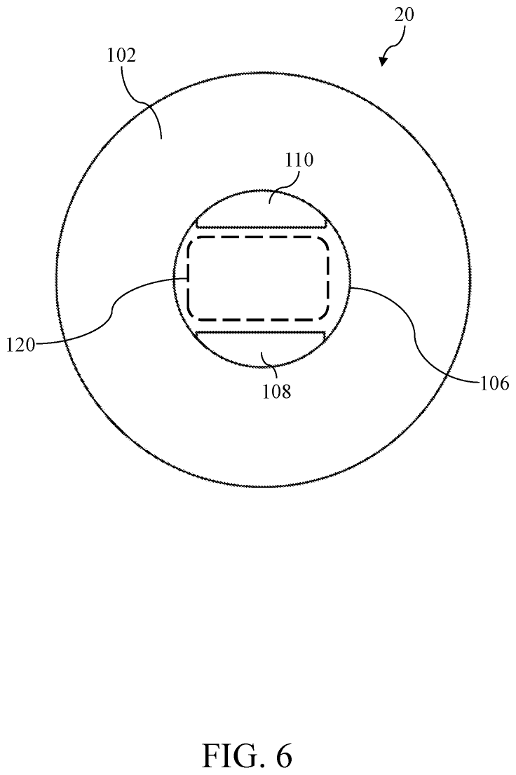

FIG. 3 shows a side elevation view of the bottle insert (20), in which supports (116) can be seen projecting from the exterior wall (114) and joining the cone (100) with the cap portion (102). The bottle catch (104) can also be seen as a wedged or friction fit implementations, which will achieve an increasingly strong coupling with the bottle during insertion. FIG. 4 is a cross-sectional side elevation view of the bottle insert (20), taken from the same perspective of FIG. 3, in which the diverters (108, 110) can be seen projecting from the interior wall (112) proximate to the hole (106). A position and dimensions of a pill (120) are simulated as a dashed circle, positioned between the diverters (108, 110) to be dispensed through the hole (106). FIG. 5 is a bottom view of the bottle insert (20), which shows a perspective similar to that of an observer from within a bottle, looking upwards at the bottle insert (20) after installation, while FIG. 6 is a top down view of the bottle insert (20), which shows a perspective similar to that of an observer from outside of the bottle, looking downwards at the cap portion (102). Each of FIGS. 5 and 6 also show a simulated position and dimensions of the pill (120) as a dashed oblong rectangle.

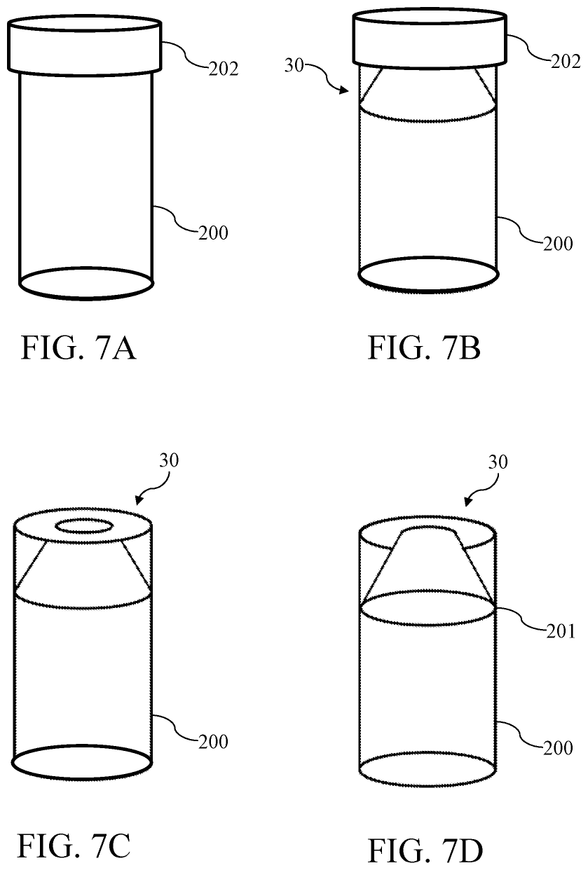

FIGS. 7A-7D show a bottle insert, such as the previously discussed bottle inserts (10, 12), coupled with an exemplary pill bottle. FIG. 7A shows a translucent plastic pill bottle (200), with an attached cap (202). The cap (202) may thread onto the pill bottle (200), and may include safety features that require the cap (202) to be pushed, squeezed, or otherwise manipulated during removal from the pill bottle (200). FIG. 7B shows the pill bottle (200) with an exemplary bottle insert (30), which may be any of the disclosed bottle inserts (10, 20, 40), installed therein, and the cap (202) threaded onto the pill bottle (200). FIG. 7C shows the pill bottle (200) and the bottle insert (30) from an upper perspective view, while FIG. 7D shows the pill bottle (200) and the bottle insert (30) from a lower perspective view. As can be seen, the bottle insert (30) may be installed within the bottle (200) to provide the described limiting features, and may also be used with the cap (202) to provide several layers of safety features to both limit access to the interior of the bottle, and to limit uncontrolled dispensing and increase the overall effort of dispensing once accessed.

As can be seen in FIG. 7D, a cone portion (201) of the bottle insert has, at its distal end, a diameter that substantially occupies the interior diameter of the bottle (200) in order to prevent pills or other objects within the bottle (200) from passing by the cone portion (201) at its exterior rather than being diverted into the cone portion (201). In some implementations, the cone portion (201) may include, at its distal end, a flexible gasket or sealing flap about its circumference that is made of rubber, flexible plastic, or other polymers or flexible materials, and that flexes as the bottle insert (30) is inserted into the bottle (200) in order to cover any gap between the cone portion (201) and the bottle (200). In some implementations, the cone portion (201) may include, at its distal end, a ridge made of plastic, rubber, or other materials about its circumference, that is adapted to pass a corresponding ridge on an interior of the bottle (200) during insertion of the bottle insert (30), and then collide with the corresponding ridge during removal of the bottle insert (30) in order to prevent or increase the difficulty of removing the bottle insert (30).

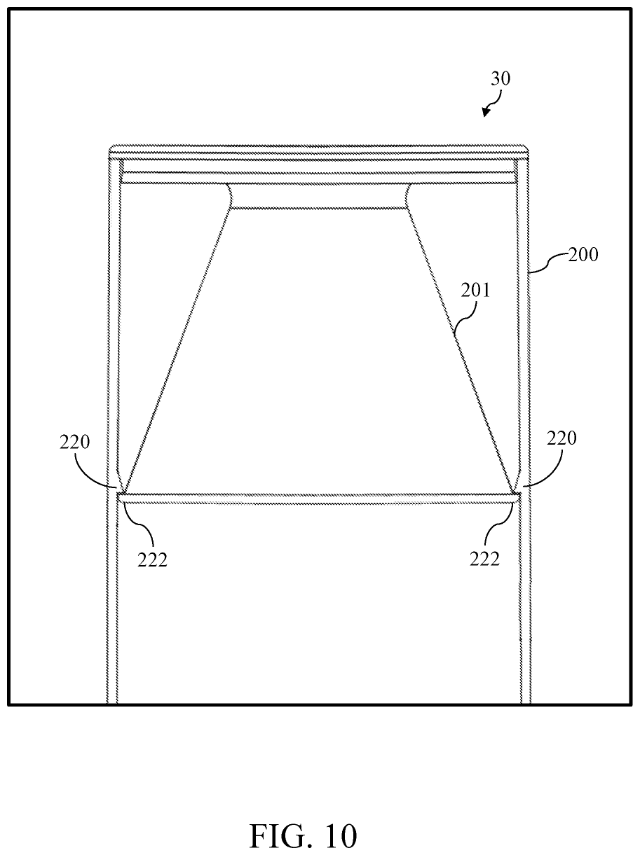

As an example, FIG. 10 shows a schematic diagram of the bottle insert (30) inserted within the bottle (200). In that figure, it can be seen that a ridge (222) of the cone portion (201) has passed beyond a ridge (220) of the bottle during insertion of the bottle insert (30), and that parallel surfaces of the ridges (220, 222) now abut each other locking the bottle insert (30) in place. The ridges (220, 222) may be angled or curved to aid in initial insertion of the bottle insert (30), and the bottle insert (30) and bottle (200) may include semi-flexible materials (e.g., plastics and other polymers) that also allow for some flexing of one or both during insertion.

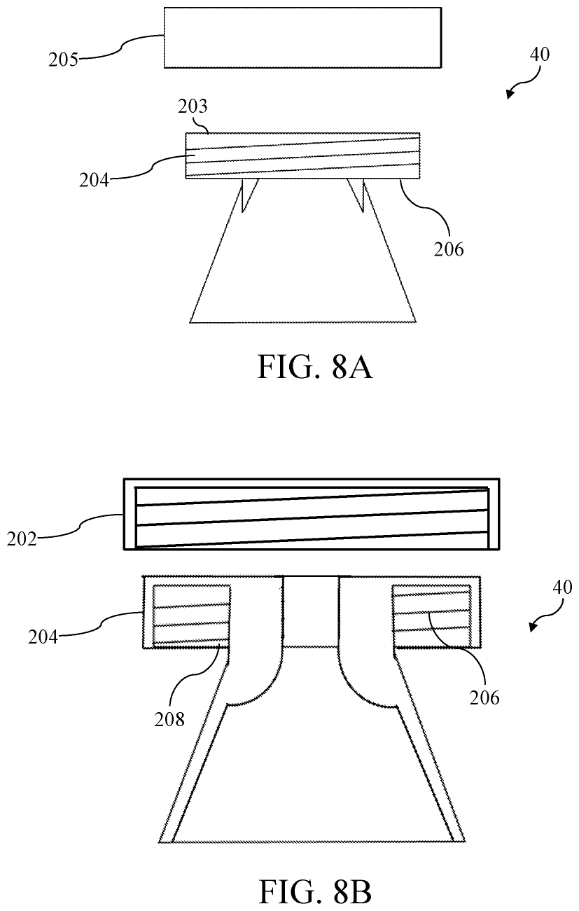

FIGS. 8A and 8B show a side elevation view, and a cross sectional side elevation view, of an exemplary threaded bottle insert (40), sharing many of the features of the previously disclosed bottle inserts (10, 20, 30). The threaded bottle insert (40) includes a double threaded cap (203), which includes exterior threading (204) and interior threading (206), instead of the bottle catch (104). The threaded bottle insert (40) may be screwed onto the bottle (200) in place of the cap (202) using the interior threading (206), instead of friction fitting within the bottle. A cap (205) may be larger than the original cap (202) for the bottle (200), and may be paired with the threaded bottle insert (40), or the external threading (204) of the threaded bottle insert (40) may be designed to match commonly available cap sizes. The cap (205) may then be screwed onto the threaded bottle insert using the external threading (204).

In this manner, each of the (205) and the threaded bottle insert (40) may provide an additional layer of safety by each including safety features that require specific actions such as squeezing, pushing, or pulling while unscrewing the cap (205) from the threaded bottle insert (40), or unscrewing the threaded bottle insert (40) from the bottle (200). The threaded bottle insert (40) may also include a lock feature (208) within the interior threading (206). The lock feature may be, for example, a catch that couples with a groove of the bottle to prevent unscrewing, or may be an adhesive such as a tape, glue, or other material that is activated as a result of the threaded bottle insert (40) being screwed onto the bottle, and permanently couples the insert to the bottle. As one example, the lock feature (208) could be an airtight polymer bubble of chemical adhesive that is crushed, ripped, or otherwise punctured as a result of threading the threaded bottle insert (40) onto the bottle, resulting in the chemical adhesive (e.g., super glue) being released and bonding the internal threading (206) to the engaged bottle threading.

Other features and variations that may be implemented with one or more of the disclosed bottle inserts (10, 20, 30, 40) exist and will be apparent to one of ordinary skill in the art in light of this disclosure. For example, some implementations may include an audible alarm that chirps or beeps, and is activated by motions of the insert related to shaking, manipulating, rotating, and other adjusting the bottle to dispense each pill. Such alarms may activate immediately upon motion above a certain threshold, or may have a configured time threshold to allow 30-60 seconds of shaking to dispense a pill before activating an alarm for continued motion beyond that threshold, which may indicate unsupervised attempts to access the bottle.

It should also be understood that the structure of any of the disclosed bottle inserts (10, 20, 30, 40) may be permanently integrated with a bottle, rather than being inserted and semi-permanently coupled with the bottle. As an example, in some cases a manufacturer of bottles may form the insert and bottle as a single, inseparable component. As another example, a pharmacist or other person at the point of sale for medicines may glue, or may use another device (e.g., a heat gun, an incubator well, or a proprietary device that may receive an insert and pill bottle and transfer sufficient thermal heat) to heat and fuse materials, or activate an adhesive, to permanently seal the insert to the bottle.

It should also be understood that, while the dimensions of the disclosed inserts may be varied and statically produced to provide inserts suitable for common bottle sizes, cap sizes, and pill sizes, the inserts could also include features allowing them to be produced in a single form that may be modified to suit the intended application. As an example, the cap portion (102), the cone (100), the hole (106), or other elements may be manufactured to include cutting guides, breakaway portions, or other modifiable dimensions that may be customized based on the bottle and pill type in a particular situation. More specifically, the flow control portion, shown in FIG. 1-5 as the cone (100), as well as the diverters (108, 110) and the opening (106) may define a dispensing area having a profile, wherein the profile is based on the pill type. In other words, the dispensing area may be shaped and sized based on a particular pill type, with the size and shape intended to prevent more than one pill having the particular pill type from passing therethrough, to prevent a pill of the particular pill type from passing therethrough in certain orientations, or both.

As further examples, the disclosed inserts may advantageously be formed of plastics having different densities and strengths, in order to achieve a desired level of function, robustness, and reusability. Other versions may be made of various metals, or combinations of metal and plastic, to provide increase strength and resistance to tampering. In some cases, the insert may be formed as a single component (e.g., the diverter (108) may be formed into the cone (100) during manufacture, rather than assembled later from multiple components). In some cases, the insert may be produced using an additive manufacturing method, such as a 3D printer (e.g., fused deposition, resin molding) or other additive manufacturing technology. In some implementations, an additive manufacturing device may be used in coordination with a computer aided design software to build a custom insert having a desired overall size for a particular bottle, a desired hole size for a particular pill, and a desired configuration of diverters within the cone (100) to provide a desired level of difficulty in dispensing individual pills. In some cases a pharmacy or other point of sale may have an additive manufacturing device, and may use a software application to ask questions of a customer (e.g., do you have kids, do you take care of a disabled adult, what are their ages, how curious are they, have they ever defeated a safety mechanism on a pill bottle) and submit their responses, and the software may be configured with static rules to automatically generate a design for an appropriate insert, and additively manufacture the insert so that it may be inserted in the bottle at the time of sale.

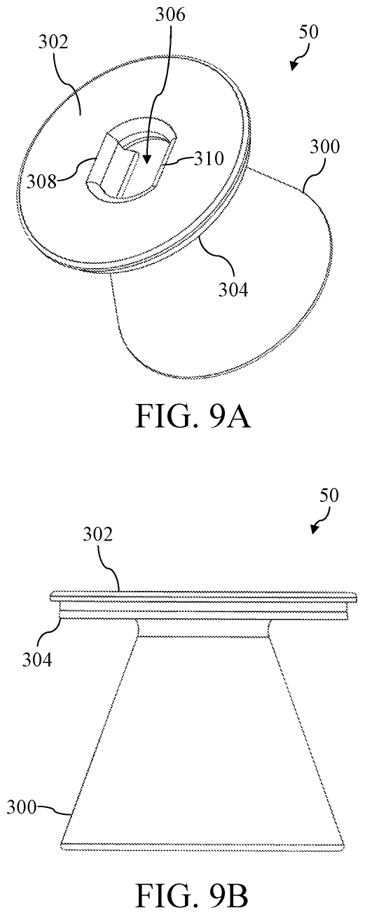

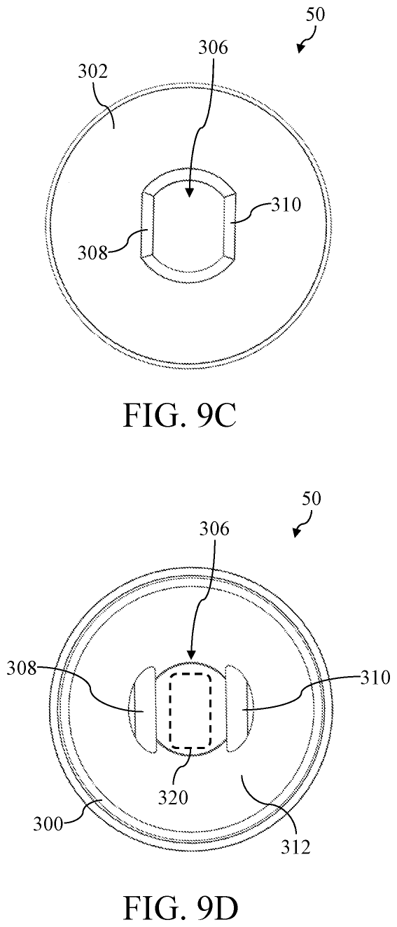

FIGS. 9A-9D show another exemplary bottle insert (50). With reference to FIG. 9A, the bottle insert (50) includes a cone portion (300) that extends outwards from a cap portion (302). The cap portion (302) includes a hole (306) that passes through the cap portion (302) and into a hollow interior of the cone portion (300) (e.g., which can be seen in FIG. 9D). The cap portion (302) also includes a bottle catch (304) about its circumference that is adapted to hold the bottle insert (50) within a correspondingly sized bottle when it is placed therein (e.g., such as shown in FIGS. 7A-7D). The bottle catch (304) may include a textured surface, an adhesive, plastic or rubber ridging, or other features that will provide a more secure coupling with a bottle when inserted. As can be seen in FIG. 7, the cone (300) may be of a diameter that substantially occupies the interior of the bottle in which it is inserted, as this will prevent the contents of the bottle (e.g., pills) from being trapped between the cone (300) and the sidewall of the bottle.

With reference to FIG. 9D, the bottle insert (50) also includes a pair of diverters (308, 310) that extend from an interior wall (312) of the cone (300) and terminate at the opening (306), similarly to the diverters (108, 110) shown in the cross sectional view of FIG. 4. As can be seen in FIGS. 9C and 9D, the diverters (308, 310) may be shaped to include curved or beveled edges that will direct a pill or other appropriately sized object that is passing through the cone (300) towards and through the opening (306). A position and dimensions of a pill (320) are illustrated in FIG. 9D with dashed lines. As can be seen, the pill (320) must be of a particular size and must be oriented in a particular way to pass through the opening (306) and be successfully dispensed. As has been described, this will increase the time and effort to dispense multiple pills through the opening (306), and may reduce or prevent the risks associated with medicines in a variety of situations. While the bottle insert (50) of FIG. 9A is shown having the cone portion (300), it should be understood that varying implementations of bottle inserts may have a flow control portion of other shapes beyond a cone. As an example, flow control portions may be pyramidal or may have other numbers of interior wall planes, may be cylindrical with a conical or curved proximal portion, may be a curved cone (e.g., a cone with a non-linear tapering), or may be any other shape that serves to direct pills or other contents towards a dispensing area.

While the pill (320) is shown as an oblong tablet, the profile (e.g., the size, area, or perimeter and shape) of the dispensing area (e.g., the portion of the opening (306) that is not obstructed by the diverters (308, 310) and through which an object may pass) may also be adapted for circular pills. For example, a circular pill typically has 2 circular planes with a flat or slightly beveled edge between. Thus, a dispensing area may be sized (e.g., by varying the size of the opening (306), the shape and curvature of the diverters (308, 310), or both) to only allow a circular pill to pass through the opening (306) with the flat edge leading.

The particular dimensions of any of the pill bottles disclosed herein may be determined automatically by a software application configured to be executed by a processor. The software application may provide a graphical user interface or other user interface that allows a user to identify characteristics of a pill, a bottle, or both. Such an identification selection may be made by, for example, selecting a bottle or pill from a pre-populated list of standard types, or by manually inputting measurements (e.g., bottle opening diameter, pill length, width, and depth) or other characteristics (e.g., pill beveling, bottle cap type). The software application may use such measurements and characteristics to produce the specifications of a corresponding bottle insert whose cap portion, cone portion, bottle catch, and other features are sized to snugly fit within the bottle, and whose diverters and opening are sized to only allow the pill to dispense from the bottle in some but not all possible orientations (e.g., where a pill may have many possible orientations relative to the opening or dispensing area, it may only pass through in a small subset of those orientations, with the orientations at which a pill may not pass being “unaligned orientation” and the orientation at which the pill may pass being “aligned orientations”). Such a software application may be useful for additively manufacturing bottle inserts at a pharmacy or other retail location or at home by a consumer, or may be useful for a large scale manufacturer of pill bottle inserts to produce specifications to match new types of bottles and new types of pills.

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1. A bottle insert adapted to be inserted into a mouth of a bottle, comprising:
(a) a cap portion that covers the mouth of the bottle;
(b) a flow control portion that extends from the cap portion into the bottle, wherein:
(i) the flow control portion defines a hollow interior therethrough; and
(ii) the perimeter of the flow control portion increases as it extends away from the cap portion;
(c) an opening defined by the cap and in fluid communication with the hollow interior of the flow control portion;
(d) at least one diverter positioned on an interior wall of the flow control portion and proximate to the opening;
wherein the at least one diverter and the opening define a dispensing area through which an object may be dispensed from the bottle.

2. The bottle insert of claim 1, wherein the at least one diverter includes two diverters positioned opposite each other on the interior wall and surrounding the opening.

3. The bottle insert of claim 1, wherein the at least one diverter curves outwards from the interior wall and terminates at the opening.

4. The bottle insert of claim 1, wherein the cap portion is adapted to friction fit within the mouth of the bottle and hold the bottle insert in place when coupled to the bottle.

5. The bottle insert of claim 1, wherein the flow control portion comprises a cone portion, and wherein a maximum diameter of the cone portion is sized to substantially occupy an interior diameter of the bottle.

6. The bottle insert of claim 5, wherein a distal end of the cone portion includes a ridge that locks against a corresponding ridge on an interior of the bottle to hold the bottle insert in place when coupled to the bottle.

7. The bottle insert of claim 1, wherein the dispensing area is configured to dispense a pill type from the bottle, and wherein the profile of the dispensing area is selected to allow at most one pill of the pill type to exit the bottle through the dispensing area at a time.

8. The bottle insert of claim 7, wherein the profile of the dispensing area is selected to:
(i) prevent a pill of the pill type from exiting the bottle through the dispensing area when the pill is oriented in any of a plurality of unaligned orientations relative to the dispensing area; and
(ii) allow the pill to exit the bottle through the dispensing area when the pill is oriented in any of a plurality of aligned orientations relative to the dispensing area.

9. The bottle insert of claim 1, further comprising a cap that is removably coupled to the cap portion, and that covers the dispensing area.

10. The bottle insert of claim 1, further comprising a threaded cap, wherein the cap portion comprises:
(i) an interior threading that corresponds to an exterior threading of the bottle such that the cap portion may be screwed onto the bottle; and
(ii) an exterior threading that corresponds to the threaded cap such that the threaded cap may be screwed onto the cap portion.

11. The bottle insert of claim 1, further comprising an audible alarm that is configured to emit an alarm sound in response to detecting a shaking motion of the bottle insert.

12. A method for providing a bottle insert comprising:
(a) identifying a bottle type and a pill type;
(b) determining a flow control portion of the bottle insert based upon the bottle type, wherein:
(i) the flow control portion extends from a cap portion of the bottle insert;
(ii) the flow control portion includes a hollow interior; and
(iii) the perimeter of the flow control portion increases as it extends away from the cap portion;
(c) determining a dispensing area through which an object may be dispensed from the bottle type based upon the pill type, wherein the dispensing area is defined by:
(i) an opening that passes through the cap portion and into the hollow interior of the flow control portion; and
(ii) at least one diverter positioned on an interior wall of the flow control portion and proximate to the opening.

13. The method of claim 12, wherein determining the flow control portion based upon the bottle type comprises:
(a) determining an interior diameter of the bottle type; and
(b) determining the flow control portion to have a maximum diameter that substantially occupies the interior diameter of the bottle type.

14. The method of claim 13, further comprising determining a profile of the cap portion based upon the interior diameter of the bottle type such that the cap portion friction fits within a mouth of the bottle type when inserted.

15. The method of claim 12, wherein determining the dispensing area based upon the pill type comprises:
(a) determining a profile of the pill type; and
(b) determining the dispensing area to allow at most one pill having the profile to exit the bottle type through the dispensing area at a time.

16. The method of claim 15, wherein determining the dispensing area based upon the pill type further comprises:
(a) determining the dispensing area to prevent a pill having the profile from exiting the bottle type through the dispensing area when the pill is oriented in any of a plurality of unaligned orientations relative to the dispensing area; and
(b) determining the dispensing area to allow the pill to exit the bottle type through the dispensing area when the pill is oriented in any of a plurality of aligned orientations relative to the dispensing area.

17. The method of claim 12, further comprising:
(a) receiving a set of user inputs via a software application; and
(b) identifying the bottle type and the pill type based upon the set of user inputs.

18. The method of claim 17, further comprising:
(a) producing a dataset usable by an additive manufacturing device to produce the bottle insert; and
(b) providing the dataset to a user of the software application.

19. The method of claim 12, further comprising producing the bottle insert and providing the bottle insert to a person in possession of a bottle of the bottle type.

20. A method comprising:
(a) identifying a bottle type;
(b) identifying a pill type;
(c) forming a bottle insert configured to be coupled with a bottle having the bottle type, wherein the bottle insert comprises:
(i) a cap defining an opening;
(ii) a flow control portion having a perimeter that increases as it extends from the cap, wherein the flow control portion defines a hollow interior, wherein the hollow interior is in fluid communication with the opening; and
(iii) a dispensing area having a profile defined by the opening and the flow control portion, wherein the profile is based on the pill type.
